(19) United States
(12) Patent Application Publication
(10) Pub. No.: US 2026/0100117 A1
(43) Pub. Date: Apr. 9, 2026

(54) NEUROMORPHIC SYSTEM FOR PARKED AIRCRAFT SURVEILLANCE

(71) Applicant: Rosemount Aerospace Inc., Burnsville, MN (US)

(72) Inventors: Robin Jacob, Eagan, MN (US); Juan Rodriguez, Windsor, SC (US); Douglas Eucken, Lakeville, MN (US)

(21) Appl. No.: 18/908,115

(22) Filed: Oct. 7, 2024

(51) Int. Cl. G08B 13/196; G06V 10/82; G06V 20/40; G06V 20/52

(52) U.S. Cl. CPC G08B 13/1965; G06V 10/82; G06V 20/44; G06V 20/52; G08B 13/19602; G08B 13/19643

(57) ABSTRACT

A system and method for surveillance are disclosed. The system includes one or more event-based cameras configured to generate a continuous stream of pixel change events based on an environment including an aircraft. The computer apparatus may include at least one processor in data communication with the one or more event-based cameras and a memory storing processor executable code for configuring the at least one processor to receive the continuous stream of pixel change events, filter the continuous stream using one or more filter modules, identify a positive detection of a feature in the environment based on the filtering, receive captured visual data, and transmit an alert based on the captured visual data.

### TECHNICAL FIELD

The present disclosure relates generally to detecting features using event-based sensors, and, more particularly, to using an event-based sensor as a low-power, continuously-operating triggering mechanism for imaging features, such as security threats near an aircraft.

### BACKGROUND

Aircrafts parked in large, unsecured areas of the airport may be prone to vandalism and theft. Aircraft surveillance is crucial to enhance the safety and security of the aircraft. Parked aircraft security typically relies heavily on existing airport surveillance infrastructure and ground staff, which drives high costs. Multiple incidents of aircraft vandalism and theft have occurred, pointing to insufficient airport surveillance measures.

Real-time processing of continuous, high-dimension signals provided by vision sensors (cameras) is challenging in terms of computational power and computationally-intensive algorithms used to extract relevant information.

### SUMMARY

A computer apparatus is disclosed in accordance with one or more illustrative embodiments of the present disclosure. In one illustrative embodiment, the computer apparatus may include one or more event-based cameras configured to generate a continuous stream of pixel change events based on an environment including an aircraft. In another illustrative embodiment, the computer apparatus may include at least one processor in data communication with the one or more event-based cameras and a memory storing processor executable code. In another illustrative embodiment, the at least one processor may be configured to receive the continuous stream of pixel change events from each of the one or more event-based cameras, filter the continuous stream using one or more filter modules, identify a positive detection of a feature in the environment based on the filtering, receive captured visual data, and transmit an alert based on the captured visual data.

In another illustrative embodiment, the at least one processor may be further configured to trigger, after the identifying and based on the positive detection, an activation of a non-event-based camera configured to generate the captured visual data of the feature in the environment, where the activation is configured to occur for a limited amount of time. In another illustrative embodiment, the non-event-based camera may include an optical image camera configured to generate periodic full-frame, discrete, sequential frames including at least red, blue, and green (RGB) channels. In another illustrative embodiment, the non-event-based camera may be configured as an external system separate from the computer apparatus. In another illustrative embodiment, the computer apparatus may include the non-event-based camera. In another illustrative embodiment, the limited amount of time may correspond to a single frame.

In another illustrative embodiment, the one or more filter modules may include an event processing module configured to detect moving features above a threshold size near the aircraft. In another illustrative embodiment, the event processing module may include a spike neural network (SNN) module. In another illustrative embodiment, the computer apparatus may further include a display, where the at least one processor may be further configured to display the alert on the display.

In another illustrative embodiment, the computer apparatus may further include a power source including an energy harvesting module configured to provide electrical power to the computer apparatus. In another illustrative embodiment, the energy harvesting module may include one or more energy harvesters including piezo-electric vibration-based harvesters, thermo-electric generators (TEGs), or photovoltaic generators, and an energy storage device including super capacitors or rechargeable batteries. In another illustrative embodiment, the energy harvesting module may be configured to harvest ambient energy on a parked aircraft using the piezo-electric vibration-based harvesters utilizing vibrations, the TEGs utilizing a temperature differential, or the photovoltaic generators utilizing solar or ambient light.

A method is disclosed in accordance with one or more illustrative embodiments of the present disclosure. In one illustrative embodiment, the method may include receiving a continuous stream of pixel change events from each of one or more event-based cameras. In another illustrative embodiment, the receiving is performed via a computer apparatus including the one or more event-based cameras configured to generate the continuous stream of pixel change events based on light intensity changes emanating from an environment including an aircraft. In another illustrative embodiment, the method may include filtering the continuous stream of pixel change events using one or more filter modules of the computer apparatus. In another illustrative embodiment, the method may include identifying, via the computer apparatus, a positive detection of a feature in the environment based on the filtering of the continuous stream of pixel change events. In another illustrative embodiment, the method may include receiving, via the computer apparatus, captured visual data. In another illustrative embodiment, the method may include transmitting, via the computer apparatus, an alert including the captured visual data.

In a further aspect, the method may include triggering, after the identifying and via the computer apparatus and based on the positive detection, an activation of a non-event-based camera configured to generate the captured visual data of the feature in the environment, where the activation is configured to occur for a limited amount of time. In another aspect, the non-event-based camera may include an optical image camera configured to generate periodic full-frame, discrete, sequential frames including at least red, blue, and green (RGB) channels. In another aspect, the non-event-based camera may be configured as an external system separate from the computer apparatus. In another aspect, the computer apparatus may include the non-event-based camera. In another aspect, the limited amount of time may correspond to a single frame.

In another aspect, the one or more filter modules may include an event processing module configured to detect moving features above a threshold size near the aircraft. In another aspect, the event processing module may include a spike neural network (SNN) module. In another aspect, the method may further include displaying, via a display, the alert. In another aspect, the method may further include providing electrical power via an energy harvesting module configured to provide the electrical power to the computer apparatus. The energy harvesting module may include one or more energy harvesters including at least one of piezo-electric vibration-based harvesters, thermo-electric generators (TEGs), or photovoltaic generators, and an energy storage device including at least one of super capacitors or rechargeable batteries. The energy harvesting module may be configured to harvest ambient energy on a parked aircraft using at least one of the piezo-electric vibration-based harvesters utilizing vibrations, the TEGs utilizing a temperature differential, or photovoltaic generators utilizing solar or ambient light.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 is a conceptual block diagram of a system, in accordance with one or more embodiments of the present disclosure.

FIG. 2 is a conceptual block diagram of a system including filter modules, in accordance with one or more embodiments of the present disclosure.

FIG. 3 is a flow diagram illustrating steps performed in a method, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

In short, neuromorphic cameras may offer low power consumption, low latency, low data usage, and the ability to operate in low-light conditions. With edge processing and energy storage capability, neuromorphic cameras may be used to enhance onboard aircraft surveillance for asset protection, proximity alerts, and real-time monitoring when an aircraft is parked.

Neuromorphic event-based camera sensors may mimic the sensing and early visual-processing characteristics of living organisms. The human retina inspires neuromorphic cameras or event-based cameras by capturing visual information based on changes in brightness rather than capturing whole images frame-by-frame. Event cameras may be asynchronous—every pixel in the camera being independent, and each pixel only reporting when its brightness changes. Event cameras typically have significantly lower data bandwidth requirements than conventional cameras. For example, if the scene stays still with no brightness changes, the bandwidth is zero or near zero.

Furthermore, processing via pixel change events reduces computational load required for visual perception by extracting only information relevant to post-processing stages. Event-based/neuromorphic cameras confer several operational advantages over conventional frame-rate cameras, including lower power, both in the sensor and follow-on computations, data rates, and bandwidth, while enabling higher pixel-change rates and dynamic range. Additionally, motion blur is generally reduced, especially at lower ambient illumination levels.

Cargo theft, aircraft vandalism, and the like may be on the rise without a conventional solution. For example, cargo theft may have increased by as much as +41% year over year in Canada/U.S. recently.

Current aircraft surveillance systems may rely on motion detection technology that are susceptible to false alarms when no security threat is present. These technologies may include power-intensive optical cameras and central processing, and limited connectivity rendering systems non-operative when the aircraft is parked due to limited operating time on battery and not powered by ground-based terminal systems.

Current surveillance measures to prevent cargo theft through real-time monitoring, such as frame-based cameras, Pulsed Infrared (PIR) and radar systems, may pose significant limitations. The current camera systems, for instance, may require large amounts of useless or bad data to be processed by the machine vision system, using expensive, power-hungry processors, high-bandwidth communications links and memory. The machine vision approach (as applied to conventional camera images), while suitable for some applications, may be unsuitable for real-time monitoring under resource constrained scenarios such as limited electrical power. Similarly, PIR and radar systems for surveillance when parked may be ineffective due to false alarms.

In contrast, embodiments of the present disclosure may provide an onboard, self-contained aircraft surveillance system that is operable when the aircraft is parked, and aircraft power is unavailable for the surveillance systems.

Using the Neuromorphic Camera and Event Processing as a front end to the system allows fusion of RGB cameras without needing to continuously run high-powered equipment using a battery. At least some neuromorphic cameras produce signals in grey-images near an edge of a moving object, and may be more difficult for a user to interpret. The RGB camera may supplement the neuromorphic camera once a detection is triggered.

Note that throughout the present disclosure, a “system” may be referred to as a “computer apparatus,” and vice versa.

Broadly, embodiments of the concepts disclosed herein are directed to a system and method including one or more event-based cameras configured to trigger one or more conventional cameras to capture images of potential vandalism or theft of cargo of a parked aircraft. The event-based cameras produce a continuous stream of event data that may be quickly processed using relatively low power, while the conventional cameras (e.g., RGB cameras) may be used to capture images that may be more easily understood by a user. In some embodiments, by only triggering the RGB cameras when the event-based cameras first detect a security threat, the power requirements for monitoring the parked aircraft may be significantly reduced compared to other conventional solutions. Other solutions may rely on various sensors such as radar or the like, which may have relatively higher rates of false positives compared to the data received and filtered using event-based cameras. In embodiments herein, the system may be run continuously on very low power despite being able to detect security threats continuously and provide image-based alerts to users.

Conventional image-processing security systems typically require a robust power source due to the relatively higher power requirements of continuously running cameras and/or intensive computation needed to continuously process the conventional images. In embodiments of the present disclosure, features (e.g., persons posing a security threat) may be identified via a continuous stream of pixel events generated using a system having vastly-lower power requirements using event-based cameras. Other conventional security systems may require more power, such as needing larger sources of energy and needing to be hooked up to and drain the aircraft's batteries. The present disclosure may improve upon the field by using such little power that it may run on its own power supply, and by using ambient power-harvesting technology. The storage devices may be charged using energy harvesting methods such as thermo-electric generation, vibration, or photovoltaic power generation based on the availability of sources.

The system may be, but is not necessarily required to be, embodied as a stand-alone system consisting of low-power neuromorphic cameras with energy storage devices recharged using matured energy harvesting methods. In embodiments, the neuromorphic camera system (e.g., ˜0.5 W) may include a low-latency event processing module and a higher-order processing module. These modules may be separated or incorporated in the same unit and housing. When the aircraft is parked, the modules may draw power from energy storage devices such as rechargeable batteries or supercapacitors.

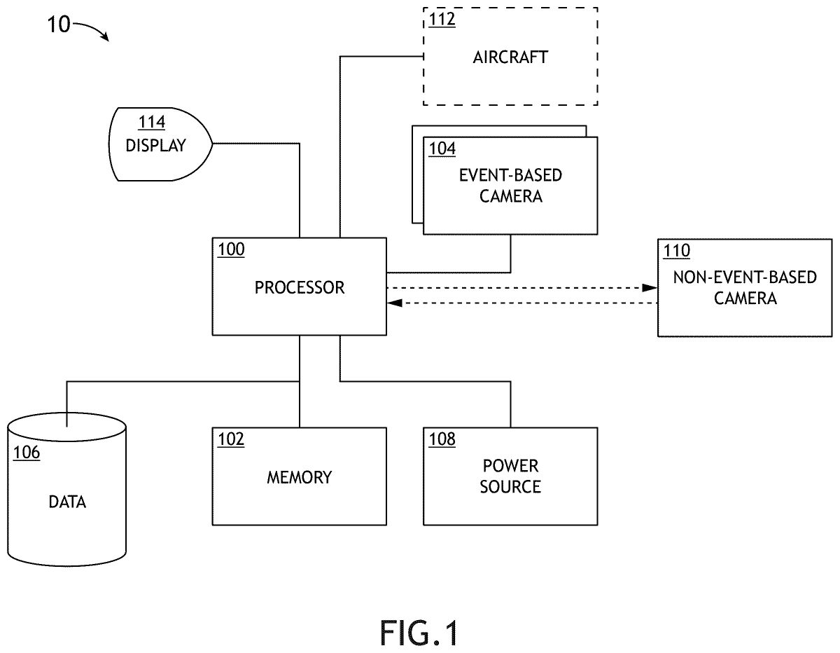

Referring to FIG. 1, a block diagram of a system 10 is illustrated, in accordance with one or more embodiments of the present disclosure. The system 10 includes a processor 100 and memory 102 for embodying processor executable code (e.g., program instructions). One or more event-based cameras 104 are communicatively connected to the processor 100 to provide a stream of pixel change events. The one or more event-based cameras 104 may be configured to generate a continuous stream of pixel change events based on light intensity changes emanating from an environment comprising an aircraft 112. At least one processor 100 is in data communication with the one or more event-based cameras 104 and the memory 102, such as being wired or wirelessly connected. The system 10 includes data 106, which may include any data, such as a continuous stream of pixel change events, program instructions for filter modules, images from a non-event-based camera 110, alerts to transmit externally, and/or the like.

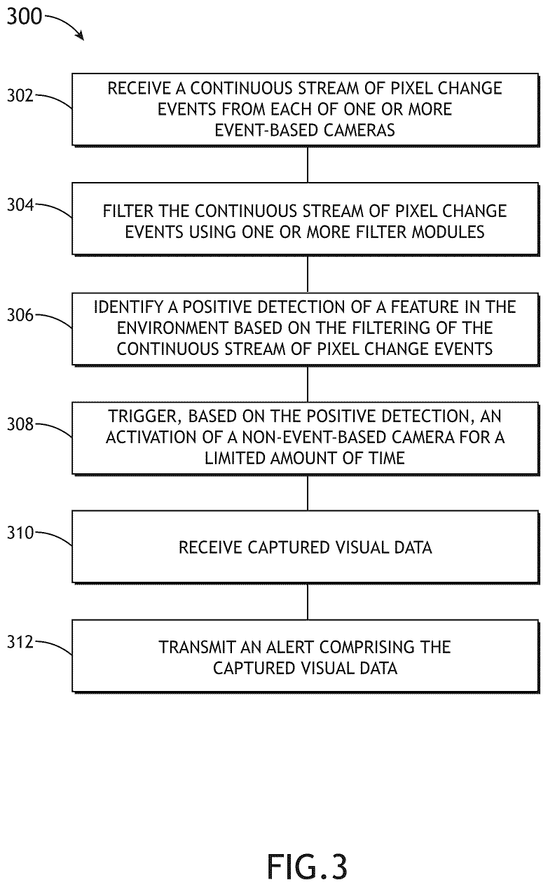

FIG. 3, described further below, illustrates one or more steps that the system 10 may be configured to perform. For example, the processor 100 is configured to identify a positive detection of one or more features based on the pixel change events.

Event-based cameras 104 produce a stream of values, each associated with a specific pixel. Changes to a pixel value produce an event registered by the at least one processor 100. Event-based cameras 104 typically operate at a much faster frequency than traditional cameras (e.g., non-event-based cameras 110); therefore, the relative movement of features may be conceptualized as a line for point-like features and a surface for edge features. That is to say as a feature (e.g., person near the aircraft 112) moves, pixels near the leading and trailing edge of the feature may record events corresponding to a change in intensity of such pixels above a threshold (e.g., more than X % change in brightness). The number of pixels registering events as measured across the entire feature may correspond to the size of the feature/object. In a filtering step, objects above a threshold size (e.g., 20 pixels) near the aircraft may be positively detected using filter modules. Note that this filtering example is nonlimiting and provided as an illustrative example only and any number of filtering steps, configurations, algorithms, and methodologies may be used to detect one or more features or security threat events.

In at least some embodiments, the system 10 is configured to activate a conventional camera, such as a non-event-based camera 110. For example, the non-event-based camera 110 may include (or be) an optical image camera configured to generate periodic full-frame, discrete, sequential frames comprising at least red, blue, and green (RGB) channels. For instance, a conventional camera may utilize a complementary metal-oxide-semiconductor (CMOS) image sensor or a charge-coupled device (CCD) sensor to capture light and convert it into electrical signals. These sensors are typically arranged in a grid-like pattern, with each pixel corresponding to a specific location on the sensor. The camera may employ a filter mosaic to capture color information, with alternating rows of red-green and green-blue filters overlaid on the sensor.

Typically, conventional security cameras may be located on the aircraft and monitor the aircraft when the aircraft is at an airport gate. These conventional cameras may be configured to only operate when the aircraft has engine power or ground-based electrical power.

In embodiments, the system 10 may be located on the aircraft 112. For example, outward facing event-based cameras 104 may be located at various positions around the aircraft 112 and mounted (or configured to be mounted) to an exterior surface of the aircraft 112.

In embodiments, the non-event-based camera 110 may be located anywhere, such as on the aircraft 112 or away from the aircraft 112 and facing the aircraft 112 or facing near the aircraft 112. The non-event-based camera 110 may be facing anywhere, such as toward an environment that includes the aircraft 10 and/or an area nearby the aircraft 112, such as an aircraft bay or outdoors aircraft parking location where the aircraft 112 is parked. Any number of non-event-based cameras 110 may be used, such as one or more, two or more, and/or the like.

For example, the non-event-based camera 110 may be configured as an external system separate from the computer apparatus 10. For instance, the non-event-based camera 110 may be a security camera that is ground-based and part of the airport surveillance infrastructure and/or non-ground-based and a separate system mounted to the aircraft 112. In this way, the non-event-based camera 110 may be a third-party system configured to be triggered by the system 10 and to return visual information back to the system 10 when triggered.

Alternatively, in at least some embodiments, the computer apparatus 10 includes the non-event-based camera 110. For example, the non-event-based camera 110 may be mounted to the exterior surface of the aircraft 112 and/or mounted to a same housing (not shown) as the system 10 and communicatively coupled (wired or wirelessly) to the processor 100.

In at least some embodiments, the computer apparatus 10 may further include a power source 108. Due to low power requirements of event-based cameras, it is contemplated that the power source 108 may have lower power requirements than traditional surveillance systems. The power source 108 may include (or be) an energy harvesting module configured to provide electrical power to the computer apparatus 10. The energy harvesting module may include (or be) one or more energy harvesters. The one or more energy harvesters may include (or be) at least one of piezo-electric vibration-based harvesters, thermo-electric generators (TEGs), or photovoltaic generators. The energy harvesting module may include (or be) an energy storage device. The energy storage device may include at least one of super capacitors or rechargeable batteries. The energy harvesting module may be configured to harvest ambient energy on a parked aircraft 112 using at least one of the piezo-electric vibration-based harvesters utilizing vibrations, the TEGs utilizing a temperature differential, or photovoltaic generators utilizing solar or ambient light. The energy harvester may be used to charge the energy storage device. The energy harvester and energy storage device may be coupled to and configured to provide power to the rest of the system 10, such as the event-based camera 104 and processor 100.

In embodiments, the system 10 may be configured to be electrically coupled to the aircraft 112 when the aircraft 112 is in operation (e.g., electronically powered on) to recharge the power source 108 (e.g., recharge the system's 10 battery or capacitors). For example, the system 10 may be configured be electrically coupled via an aircraft bus-integration connected to a main power source (e.g., battery) of the aircraft 112. To prevent parasitic drain of the aircraft battery, this operation may be configured to only occur when the aircraft 112 is powered on.

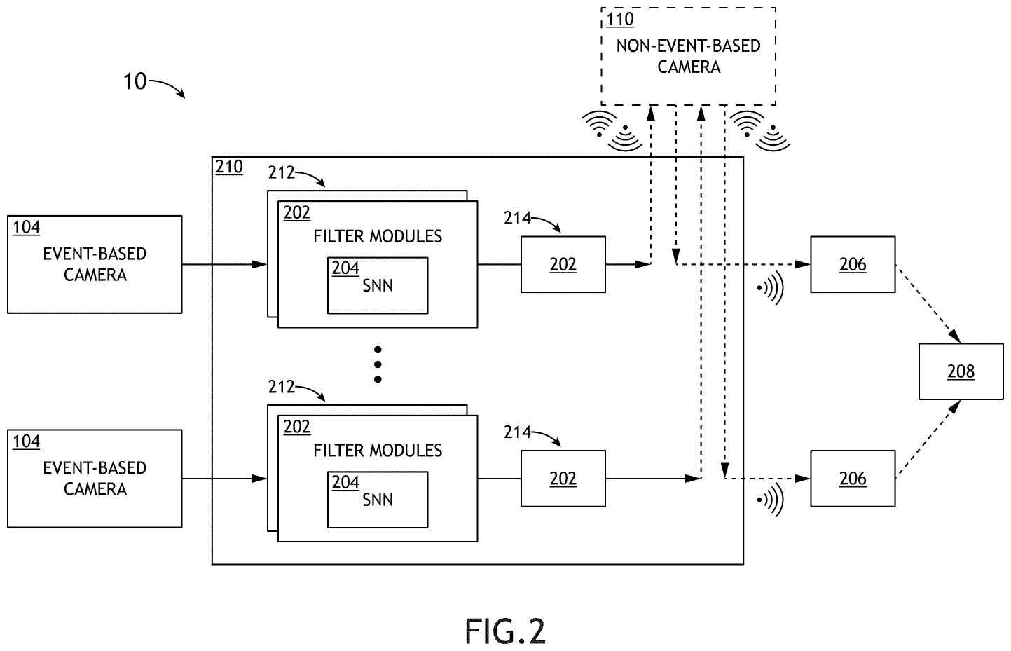

The computer apparatus 10 may further include a display 114. The display 114 may include any display, such as an LED, LCD, OLED display or the like. Additionally, and/or alternatively, the system 10 may be configured to be communicatively coupled to an (external) display. For instance, the system 10 may be configured to wirelessly communicate with a server to send alerts including RGB images to a user's phone for viewing security threats near the aircraft 112. An example of a server or user device is target node 208 shown in FIG. 2 and an example of an alert is alert 206 in FIG. 2.

FIG. 2 illustrates a conceptual block diagram of a system 10 including filter modules 202, in accordance with one or more embodiments of the present disclosure.

For purposes of the present disclosure, a “module” such as a filter module 202 is software and/or hardware configured to perform one or more actions. A “module” may mean, but is not limited to, program instructions or a sub-set of program instructions configured to be executed on a processor. For example, a module may be a function or set of functions defined in a programming language and configured to receive an input, generate an output, and/or perform some task. For example, a module may include heuristic program instructions (e.g., python code) stored on memory 102, neural networks such as SNNs, hardware such as Field Programmable Gate Arrays (FPGAs), and/or the like. For example, modules may be functional code in a computer application program, a set of functions, entire applications, hardware-accelerated neural networks, and/or the like.

The system 10 and the data processing modules 210 thereof may include one or more filter modules 202. The filter modules 202 may be run in parallel and a corresponding set of filter modules 202 may be used for each event-based camera 104 of multiple event-based cameras 104. Multiple filter modules 202 may be used in sequence and/or in parallel for each event-based camera 104. For example, a filter module 202 may include (or be) a spike neural network (SNN) module 204. An SNN is a type of artificial neural network that may model neurons more closely after biological neurons by incorporating the concept of time and discrete events known as spikes. For example, an SNN may utilize neurons that process input data as a series of spikes over time, rather than as continuous values, allowing for the efficient handling of event-based data streams from event-based cameras 104. In certain implementations, the SNN module 204 may employ models like the leaky integrate-and-fire (LIF) neuron, where a neuron accumulates incoming spikes and fires an output spike when a threshold is reached, then resets. This approach may enable the filter module 202 to process spatio-temporal information in real time, enhancing tasks such as pattern recognition, feature extraction, or noise filtering in the system 10.

The one or more filter modules 202 may be part of one or more first modules 212 and one or more second modules 214.

The one or more first modules 212 may process the pixel changes first, or nearly first. In some embodiments, the one or more first modules 212 may be referred to as low-latency modules 212, event processing modules 212, low-latency event processing modules 212, or the like. The event processing module 212 may be configured to detect moving features above a threshold size near the aircraft 112. The event processing module 212 may include a SNN module 204.

The one or more second modules 214 (e.g., higher order video processing modules 214) may process an output received from the one or more first modules 212. The second module 214 may be configured to perform additional filtering (e.g., data processing) based on video data. For example, in this context, video data may mean data spanning more than one time step, wherein the data is derived from (e.g., filtered from, inferred from, calculated from) the pixel change events. In a simplified example, this may include tracking a feature across a period of time (e.g., more than 1 second) to confirm its existence (e.g., reduce false positives).

The first modules 212 and second modules 214 may be disposed on one or more processors 100, such as the same processor 100 or separate processors 100. For example, the first module 212 may include the SNN module 204 and may be disposed on a single processor chip adjacent to and directly coupled to the event-based camera 104 for low latency purposes. Data (e.g., filtered data, inferences, etc.) from the SNN module 204 may be continuously passed, or triggered to be passed based on a value output by the SNN module 204, to the second module 214.

As is described in steps 304-306 of FIG. 3, the data from the event-based cameras 104 may be filtered and used to identify a “positive detection.” The positive detection may correspond to a detection of a person, such as a person potentially committing an act of vandalism or theft. This may, for example, simply mean that the filters culminated in a positive detection, such as a set of values and threshold breaches output by the filter modules 202 that exceed some threshold value or logical test for detecting the features. This could be any threshold value, such as a spike value of a SNN module 204, and/or a threshold value corresponding to a number of pixels having corresponding events, and/or the like.

In embodiments, the system 10 may be configured to run continuously on 1 watt or less. For example, the system 10 may be configured to run continuously on less than 0.5 watt or less. For instance, the event-based camera 104 may consume milliwatts, less than one watt. A low powered processor (e.g., event processing module 212) may be configured to consume only milliwatts to run machine learning models (e.g., Tiny ML models) for resource constrained devices. Other conventional aircraft surveillance systems are likely not capable of running at such low power levels.

Furthermore, communication protocols such as at least one of LTE-M or Bluetooth Low Energy (BLE) may be used for any transmission or data transfer step of the present disclosure for reduced power. For instance, a target node 208 such as airport security server may be configured to receive an alert 206 including a non-event-based camera image of the positive detection event through this communication protocol by virtue of the system 10 being configured to use such a protocol. The system 10 may be configured to select a particular communication protocol based on the required range and available communication options in the aircraft 112 and/or airport infrastructure and the compatible range and options available to the system 10.

FIG. 3 illustrates a flow diagram illustrating steps performed in a method 300, in accordance with one or more embodiments of the present disclosure. Note that method 300 may be implemented all or in part by system 10. For example, the memory 102 may store processor executable code for configuring the at least one processor 100 to receive the continuous stream of pixel change events from each of the one or more event-based cameras 104. The processor executable code may be configured to filter the continuous stream of pixel change events using one or more filter modules 202. The processor executable code may be configured to identify a positive detection of a feature in the environment based on the filtering of the continuous stream of pixel change events. The processor executable code may be configured to trigger, based on the positive detection, an activation of a non-event-based camera 110. The non-event-based camera 110 may be configured to generate captured visual data of the feature in the environment. The processor executable code may be configured to receive the captured visual data. The processor executable code may be configured to transmit an alert comprising the captured visual data.

At step 302, the continuous stream of pixel change events from each of the one or more event-based cameras 104 is received. For example, the processor 100 and/or memory 102 may receive the pixel change events using wired connections.

At step 304, the continuous stream of pixel change events is filtered using one or more filter modules 202. For example, noise may be removed and a set of one or more thresholds may be used to detect features.

For example, a filter module 202 (e.g., a neural network module such as a SNN module 204) may be configured to (e.g., trained to) identify one or more persons based on the continuous stream of pixel change events. For instance, the neural network module 202 may be trained on pixel change events to identify persons. In particular, for example, the neural network module 202 may be configured to detect security threats such as vandalism and/or theft of aircraft 112 components. For instance, the neural network module 202 may be trained on example training data labeled to generate a positive detection (e.g., spike) in the neural network based on such data.

However, note that the filter modules 202 are not limited to such an example, and any filter technique may be used. For example, the filter modules 202 may include, but are not limited to, heuristic (e.g., hand coded) computer vision (CV) methods, spatial filters configured to group pixel change events based on proximity, temporal filters to analyze event timing patterns, edge detection filters to identify object boundaries, noise reduction filters to remove spurious events, and threshold-based filters to isolate events exceeding predefined intensity or frequency levels. Additionally, the filter modules 202 may incorporate motion tracking algorithms to follow moving objects across the field of view, clustering algorithms to group related events, and pattern recognition filters to identify specific shapes or event distributions characteristic of particular objects or activities of interest.

It is contemplated that embodiments may combine heuristic CV methods with machine learning (e.g., SNN modules 204) to leverage the strengths of both to achieve more accurate and efficient motion detection.

Furthermore, the filter modules 202 may be adaptively configured based on environmental conditions. For instance, the filters may dynamically adjust their sensitivity thresholds based on ambient lighting conditions, modify their spatial or temporal window sizes in response to detected object velocities, or selectively activate specific filter types based on the current operational mode of the aircraft 112.

At step 306, a positive detection of a feature in the environment is identified based on the filtering of the continuous stream of pixel change events. For example, if one or more of the thresholds is breached, the system 10 may be configured to make a “positive detection” of a feature and/or security threat event or the like.

At step 308, based on the positive detection, an activation of a non-event-based camera 110 is triggered. Activation may include, but is not necessarily limited to, powering on, and/or capturing an image and/or video. The non-event-based camera 110 is configured to generate captured visual data of the feature in the environment, such as by virtue of being aimed at the environment/aircraft. For instance, the non-event-based camera 110 may be a fixed security camera of an airport. The activation may be configured to occur for a limited amount of time. For example, a single frame/image may be configured to be captured. By way of another example, a video of a limited duration (e.g., a duration of less than 30 seconds) may be configured to be captured.

At step 310, the captured visual data is received. For example, the captured visual data may be received by the processor 100 and/or memory 102 via wireless communication protocols mentioned herein (or the like). The captured visual data may include images (e.g., a single frame, high-resolution RGB image) and/or video footage of the detected feature, providing detailed visual information more easily understood by a user.

At step 312, an alert 206 comprising the captured visual data is transmitted. The alert 206 may be transmitted to a designated target node 208. For example, the target node 208 may be at least one of: a user node (e.g., user's phone), a ground control station, security personnel device/system, a server on a cloud network, or an automated response system. The alert 206 may include not only the captured visual data but also metadata such as timestamp, camera identifier, aircraft location, and any preliminary analysis results. For example, the alert 206 may include both the captured visual data and a timestamp.

In an optional step (not shown), the alert 206 is transmitted to be displayed on a display 114. For example, the alert 206 may be displayed on a display of the target node 208, such as an airport security display or user device.

The one or more processors 100 of system 10 may include any one or more processing elements known in the art. In this sense, the one or more processors 100 may include any microprocessor device configured to execute algorithms and/or instructions. In one embodiment, the one or more processors 100 may consist of a desktop computer, mainframe computer system, workstation, image computer, parallel processor, or other computer system (e.g., networked computer) configured to execute a program configured to operate the system 10, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium (e.g., memory 102). Moreover, different subsystems of the system 10 may include processor or logic elements suitable for carrying out at least a portion of the steps described throughout the present disclosure. Therefore, the above description should not be interpreted as a limitation on the present invention but merely an illustration.

The memory medium 102 may include any storage medium known in the art suitable for storing program instructions executable by the associated one or more processors 100. For example, the memory medium 102 may include a non-transitory memory medium. For instance, the memory medium 102 may include, but is not limited to, a read-only memory, a random access memory, a magnetic or optical memory device (e.g., disk), a magnetic tape, a solid state drive and the like. In another embodiment, it is noted herein that the memory 102 is configured to store one or more results from the system 10 and/or the output of the various steps described herein. It is further noted that memory 102 may be housed in a common controller housing with the one or more processors 100. In an alternative embodiment, the memory 102 may be located remotely with respect to the physical location of the processors and system 10. For instance, the one or more processors 100 of system 10 may access a remote memory (e.g., server), accessible through a network (e.g., internet, intranet and the like). In another embodiment, the memory medium 102 stores the program instructions for causing the one or more processors 100 to carry out the various steps described through the present disclosure.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

In another embodiment, the system 10 may be configured to receive and/or acquire data or information from other systems by a transmission medium that may include wireline and/or wireless portions. In another embodiment, the system 10 may be configured to transmit data or information (e.g., the output of one or more processes disclosed herein) to one or more systems or sub-systems by a transmission medium that may include wireline and/or wireless portions. In this manner, the transmission medium may serve as a data link between the system 10 and other subsystems. Moreover, the system 10 may send data to external systems via a transmission medium (e.g., network connection).

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A computer apparatus comprising:
one or more event-based cameras configured to generate a continuous stream of pixel change events based on an environment comprising an aircraft; and
at least one processor in data communication with the one or more event-based cameras and a memory storing processor executable code for configuring the at least one processor to:
receive the continuous stream of pixel change events from each of the one or more event-based cameras;
filter the continuous stream of pixel change events using one or more filter modules;
identify a positive detection of a feature in the environment based on the filtering of the continuous stream of pixel change events;
receive captured visual data; and
transmit an alert based on the captured visual data.

2. The computer apparatus of claim 1, wherein the at least one processor is further configured to:
trigger, after the identifying and based on the positive detection, an activation of a non-event-based camera configured to generate the captured visual data of the feature in the environment, wherein the activation is configured to occur for a limited amount of time.

3. The computer apparatus of claim 2, wherein the non-event-based camera comprises an optical image camera configured to generate periodic full-frame, discrete, sequential frames comprising at least red, blue, and green (RGB) channels.

4. The computer apparatus of claim 2, wherein the non-event-based camera is configured as an external system separate from the computer apparatus.

5. The computer apparatus of claim 2, wherein the computer apparatus comprises the non-event-based camera.

6. The computer apparatus of claim 2, wherein the limited amount of time corresponds to a single frame.

7. The computer apparatus of claim 1, wherein the one or more filter modules comprise an event processing module configured to detect moving features above a threshold size near the aircraft.

8. The computer apparatus of claim 7, wherein the event processing module comprises a spike neural network (SNN) module.

9. The computer apparatus of claim 1, further comprising a display, wherein the at least one processor is further configured to display the alert on the display.

10. The computer apparatus of claim 1, further comprising a power source comprising an energy harvesting module configured to provide electrical power to the computer apparatus, the energy harvesting module comprising at least one of:
one or more energy harvesters comprising at least one of:
piezo-electric vibration-based harvesters;
thermo-electric generators (TEGs); or
photovoltaic generators; and
an energy storage device comprising at least one of:
super capacitors; or
rechargeable batteries;
wherein:
the energy harvesting module is configured to harvest ambient energy on a parked aircraft using at least one of:
the piezo-electric vibration-based harvesters utilizing vibrations;
the TEGs utilizing a temperature differential; or
photovoltaic generators utilizing solar or ambient light.

11. A method comprising:
receiving a continuous stream of pixel change events from each of one or more event-based cameras, wherein the receiving is performed via a computer apparatus comprising the one or more event-based cameras configured to generate the continuous stream of pixel change events based on light intensity changes emanating from an environment comprising an aircraft;
filtering the continuous stream of pixel change events using one or more filter modules of the computer apparatus;
identifying, via the computer apparatus, a positive detection of a feature in the environment based on the filtering of the continuous stream of pixel change events;
receiving, via the computer apparatus, captured visual data; and
transmitting, via the computer apparatus, an alert comprising the captured visual data.

12. The method of claim 11, further comprising:
triggering, after the identifying and via the computer apparatus and based on the positive detection, an activation of a non-event-based camera configured to generate the captured visual data of the feature in the environment, wherein the activation is configured to occur for a limited amount of time.

13. The method of claim 12, wherein the non-event-based camera comprises an optical image camera configured to generate periodic full-frame, discrete, sequential frames comprising at least red, blue, and green (RGB) channels.

14. The method of claim 12, wherein the non-event-based camera is configured as an external system separate from the computer apparatus.

15. The method of claim 12, wherein the computer apparatus comprises the non-event-based camera.

16. The method of claim 12, wherein the limited amount of time corresponds to a single frame.

17. The method of claim 11, wherein the one or more filter modules comprise an event processing module configured to detect moving features above a threshold size near the aircraft.

18. The method of claim 17, wherein the event processing module comprises a spike neural network (SNN) module.

19. The method of claim 11, further comprising displaying, via a display, the alert.

20. The method of claim 11, further comprising providing electrical power via an energy harvesting module configured to provide the electrical power to the computer apparatus, the energy harvesting module comprising at least one of:
one or more energy harvesters comprising at least one of:
piezo-electric vibration-based harvesters;
thermo-electric generators (TEGs); or
photovoltaic generators; and
an energy storage device comprising at least one of:
super capacitors; or
rechargeable batteries;
wherein:
the energy harvesting module is configured to harvest ambient energy on a parked aircraft using at least one of:
the piezo-electric vibration-based harvesters utilizing vibrations;
the TEGs utilizing a temperature differential; or
photovoltaic generators utilizing solar or ambient light.
